(19) United States
(12) Patent Application Publication
(10) Pub. No.: US 2012/0082074 A1
(43) Pub. Date: Apr. 5, 2012

(54) RADIO COMMUNICATION DEVICE

(75) Inventor: Mitsuhiro SUGIYAMA, Tokyo (JP)

(73) Assignee: MITSUMI ELECTRIC CO., LTD., Tokyo (JP)

(21) Appl. No.: 13/249,245

(22) Filed: Sep. 30, 2011

(30) Foreign Application Priority Data
Oct. 1, 2010 (JP) NO. 2010-224115
Sep. 12, 2011 (JP) NO. 2011-198776

(51) Int. Cl. H04W 88/02

(52) U.S. Cl. 370/310

(57) ABSTRACT

A radio communication device includes a mounting substrate and a shielding case to cover circuits mounted on the substrate. A first surface of the substrate includes an input/output area where a transmitting/receiving unit of an RF signal is mounted, an amplification area where an amplifying unit to amplify the RF signal from the transmitting/receiving unit is mounted, an RF area where an RF processing unit to process the. RF signal is mounted, and a baseband area where a baseband processing unit to process a baseband signal is mounted. A second surface of the substrate includes a crystal oscillator arranged to generate a reference clock signal which is supplied to the RF processing unit and the baseband processing unit.

### CROSS-REFERENCE TO RELATED APPLICATION

This application is based upon and claims the benefit of priority of Japanese patent application No. 2010-224115, filed on Oct. 1, 2010, and Japanese patent application No. 2011-198776, filed on Sep. 12, 2011, the entire contents of which are incorporated by reference in their entirety.

### BACKGROUND OF THE INVENTION

1. Field of the Invention

The present disclosure relates to a radio communication device including a mounting substrate and a shielding case to cover a circuit mounted on the mounting substrate.

2. Description of the Related Art

Conventionally, WiMAX (Worldwide Interoperability for Microwave Access) is known as one of the telecommunications standards for performing wireless communications. In recent years, WiMAX is expected as a connection means for high-speed mobile communications and also expected as a connection means for use in areas where use of DSL (digital subscriber line) is difficult, in small population areas, in the construction of (optical and cable) high-speed communication lines, etc.

In a radio communication device which performs communication by using WiMAX, a high-output type power amplifier for realizing a transmission range of 2-3 km is provided. FIG. 7 is a diagram showing the composition of a mounting substrate of a radio communication device 10 according to the related art which performs communication by using WiMAX.

As shown in FIG. 7, in the radio communication device 10, component parts are mounted on both front and back surfaces of a mounting substrate 20. On the front surface of the mounting substrate 20, antennas 11 and 12, a power amplifier 13, an RF-IC (radio-frequency integrated circuit) 14, a crystal oscillator 15, a BB-IC (baseband integrated circuit) 16, and an SDRAM (synchronous dynamic random access memory) 17 are mounted. On the back surface of the mounting substrate 20, a flash memory 18, a power supply control circuit 19, and a connector 21 are mounted.

In the radio communication device 10, the antenna 11 receives a signal. The received signal is sent to the RF-IC 14 and the BB-IC 16, the signal is processed by the RF-IC 14 and the BB-IC 16, and the processed signal is output from the connector 21. A reference clock signal internally generated is supplied to the RI-IC 14 and the BB-IC 16.

In the radio communication device 10, the signal received from the connector 21 is sent to the RF-IC 14 and the BB-IC 16, the signal is processed by the RF-IC 14 and the BB-IC 16 and amplified by the power amplifier 13, and the amplified signal is transmitted from the antenna 12.

By taking into consideration of the above-described signal flow, the power amplifier 13, the RF-IC 14 and the BB-IC 16 are arranged in the radio communication device 10. For example, Japanese Laid-Open Patent Publication No. 11-251717 discloses a component layout method which takes into consideration of the above-described signal flow. The component layout method of Japanese Laid-Open Patent Publication No. 11-251717 is a design method of arranging component parts (active elements) in a design of a multilayer printed circuit board.

In the radio communication device 10 according to the related art, the crystal oscillator 15 which generates a reference clock signal is mounted on the front surface which is the same as the surface on which the power amplifier 13 is mounted.

However, in the radio communication device 10 according to the related art, the power amplifier 13 is a high-output type power amplifier, and a heating value of the power amplifier 13 is high. Hence, the operation of the crystal oscillator 15 may be considerably affected by the heat from the power amplifier 13. Hence, there is a possibility that the reference clock signal to be supplied from the crystal oscillator 15 to the RF-IC 16 or the BB-IC 17 may not be output correctly.

### SUMMARY OF THE INVENTION

In one aspect, the present disclosure provides a radio communication device which is capable of increasing the stability and reliability of a crystal oscillator.

In an embodiment which solves or reduces one or more of the above-described problems, the present disclosure provides a radio communication device including a mounting substrate and a shielding case to cover circuits mounted on the substrate, a first surface of the substrate including: an input/output area where a transmitting/receiving unit of an RF signal is mounted on the first surface; an amplification area, located adjacent to the input/output area, where an amplifying unit to amplify the RF signal from the transmitting/receiving unit is mounted on the first surface; an RF area, located adjacent to the amplification area, where an RF processing unit to process the RF signal from the transmitting/receiving unit is mounted on the first surface; and a baseband area, located adjacent to the RF area is adjoined, where a baseband processing unit to process a baseband signal which is an intermediate signal before modulation of the RF signal or an intermediate signal after demodulation is mounted on the first surface, and a second surface of the substrate opposite to the first surface including a crystal oscillator arranged on the second surface to generate a reference clock signal which is supplied to the RF processing unit and the baseband processing unit.

In an embodiment which solves or reduces one or more of the above-described problems, the present disclosure provides a radio communication device including a mounting substrate and circuits mounted on the substrate, a single surface of the substrate including: an input/output area where a transmitting unit to transmit an RF signal and a receiving unit to receive an RF signal are mounted on the surface; a transmitting/receiving unit area where a transmitting circuit to supply the RF signal to the transmitting unit and a receiving circuit to receive the RF signal received by the receiving unit are mounted on the surface; an amplification area where an amplifying unit to amplify the RF signal to be transmitted by the transmitting unit is mounted on the surface; a communication control area where a communication control unit including an RF processing unit to process the RF signal to be transmitted by the transmitting unit or received by the receiving unit, and a baseband processing unit to process a baseband signal which is an intermediate signal before modulation of the RF signal or an intermediate signal after demodulation is mounted on the surface; and a crystal oscillation area where a crystal oscillator to generate a reference clock signal to be supplied to the communication control unit is mounted on the surface, wherein a part of the communication control area is arranged between the amplification area and the crystal oscillation area.

Other objects, features and advantages of the present disclosure will be apparent from the following detailed description when read in conjunction with the accompanying drawings.

### BRIEF DESCRIPTION OF THE DRAWINGS

FIG. 1 is a diagram showing the outline of a radio communication device of a first embodiment of the present disclosure.

FIG. 2 is a block diagram showing the functional composition of the radio communication device of the first embodiment.

FIG. 3 is a diagram showing the composition of a mounting substrate of the radio communication device of the first embodiment.

FIG. 4 is a diagram showing the composition of a mounting substrate of a radio communication device of a second embodiment of the present disclosure.

FIG. 5 is a block diagram showing the functional composition of a radio communication device of a third embodiment of the present disclosure.

FIG. 6 is a diagram showing the composition of a mounting substrate of the radio communication device of the third embodiment.

FIG. 7 is a diagram showing the composition of a mounting substrate of a radio communication device according to the related art which performs communication by using WiMAX.

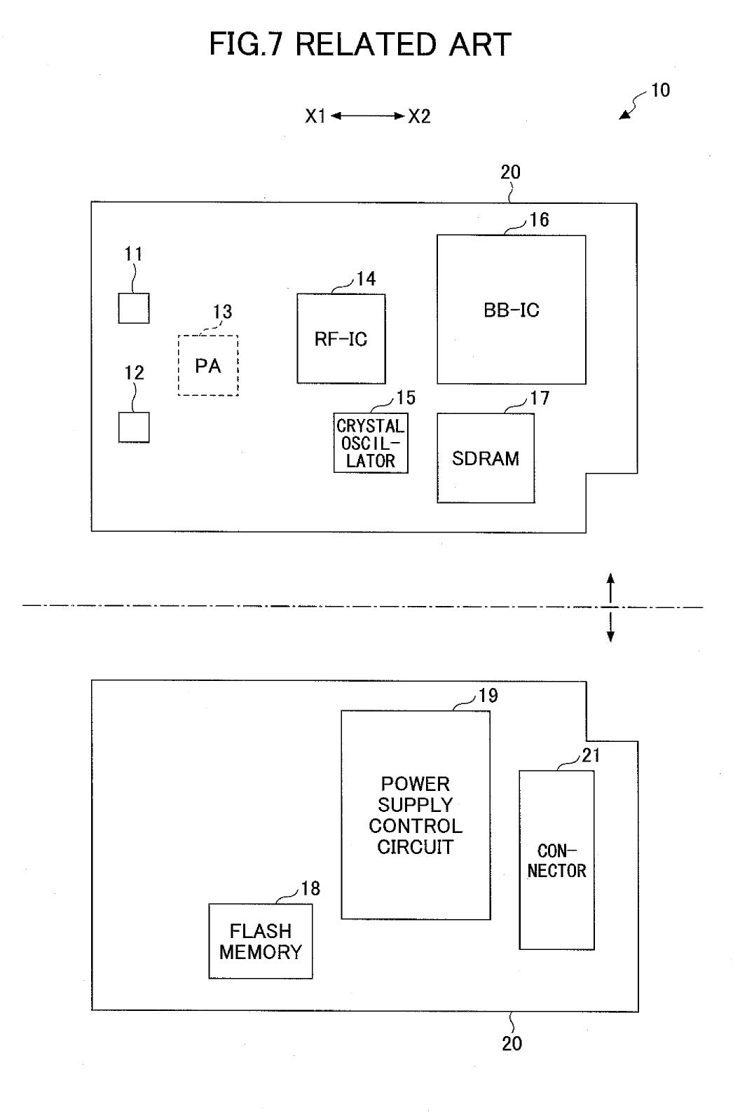

### DETAILED DESCRIPTION OF PREFERRED EMBODIMENTS

A description will be given of embodiments of the present disclosure with reference to the accompanying drawings.

In a first embodiment of the present disclosure, a crystal oscillator and a power amplifier having a high heating value are mounted on different surfaces of a substrate respectively, thereby preventing the crystal oscillator from being considerably affected by the heat generated in the power amplifier.

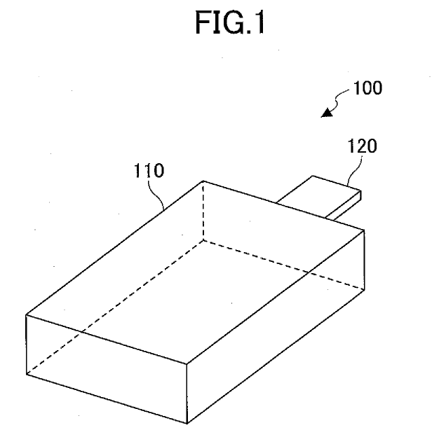

FIG. 1 is a diagram showing the outline of a radio communication device of a first embodiment of the present disclosure. The radio communication device 100 of this embodiment is adapted to perform wireless communication by using WiMAX (Worldwide Interoperability for Microwave Access) which is known as one of the telecommunications standards for performing wireless communication.

As shown in FIG. 1, the radio communication device 100 of this embodiment includes a shielding case 110 and a USB (universal serial bus) connector 120. A mounting substrate 300 which will be described later is accommodated in the case 110. The case 110 of this embodiment is made of metal.

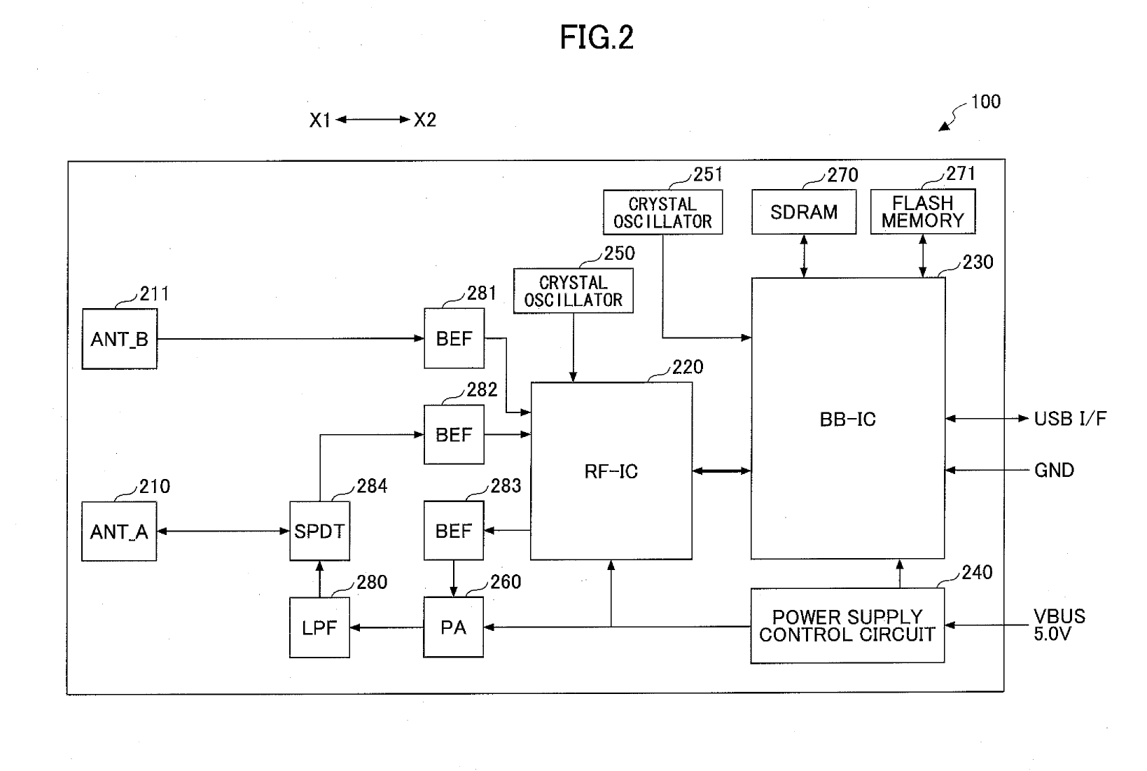

FIG. 2 is a block diagram showing the functional composition of the radio communication device of the first embodiment.

As shown in FIG. 2, the radio communication device 100 of this embodiment is constructed to include antennas 210 and 211, an RF-IC 220, a BB-IC 230, a power supply control circuit 240, crystal oscillators 250, 251, a power amplifier (PA) 260, an SDRAM 270, a flash memory 271, an LPF (low-pass filter) 280, BPFs (band-pass filters) 281, 282, 283, and an SPDT (single pole double throw) 284. The respective component parts are mounted on a mounting substrate 300 which will be described later, and the mounting substrate 300 is accommodated in the case 110.

The antenna 210 of this embodiment is adapted to perform transmission and reception of a signal. The antenna 211 is adapted to receive a signal.

The RF-IC 220 is an integrated circuit for processing an RF signal. The BB-IC 230 is an integrated circuit for processing a baseband signal which is an intermediate signal before modulation or an intermediate signal after demodulation. The power supply control circuit 240 is an assembly of circuits which manage the power supply supplied to the respective circuits. The crystal oscillator 250 generates and outputs a reference clock signal to the RF-IC 220 and the BB-IC 230 as an operating signal. The RF-IC 220 and the BB-IC 230 operate on the basis of this reference clock signal.

The crystal oscillator 251 provides a clock function for the radio communication device 100. The power amplifier 260 amplifies a transmitting signal output from the RF-IC 220. The signals and data which are processed in the radio communication device 100 are stored in the SDRAM 270 and the flash memory 271.

The LPF 280 filters the output of the power amplifier 260. The SPDT 284 performs the switching to select one of the transmission mode and the reception mode of the antenna 210. The BPF 281 filters the signal received from the antenna 211. The BPF 282 filters the signal received from the antenna 210. The BPF 283 filters the signal output from the RF-IC 220.

In the radio communication device 100 of this embodiment, when receiving a signal, the mode of the antenna 210 is switched to the reception mode by the SPDT 284, and signals are received by the antennas 210 and 211.

The signals received by the antennas 210 and 211 are sent to the RF-IC 220 through the BPF 281 and the BPF 282 respectively. These signals are sent from the RF-IC 220 to the BB-IC 230 and output from the BB-IC 230 to the USB connector 120. The USB connector 120 is inserted into, for example, a slot of a personal computer and the received signal is sent to the personal computer to which the radio communication device 100 is connected.

In the radio communication device 100 of this embodiment, when receiving a signal, the signal flows in a sequence of the RF-IC 220 and the BB-IC 230. This signal flow is in accordance with the X1 to X2 direction as indicated by the arrow in FIG. 2.

In the radio communication device 100 of this embodiment, when transmitting a signal, the antenna 210 is connected to the LPF 280 through the switching operation by the SPDT 284. A signal received through the USB connector 120 is sent to the BPF 283 through the BB-IC 230 and the RF-IC 220. The signal filtered by the BPF 283 is amplified by the power amplifier 260 and the amplified signal is supplied to the LPF 280. The signal filtered by the LPF 280 is transmitted from the antenna 210.

In the radio communication device 100 of this embodiment, when transmitting a signal, the signal flows in a sequence of the BB-IC 230, the RF-IC 220 and the power amplifier 260. This signal flow is in accordance with the X2 to X1 direction as indicated by the arrow in FIG. 2.

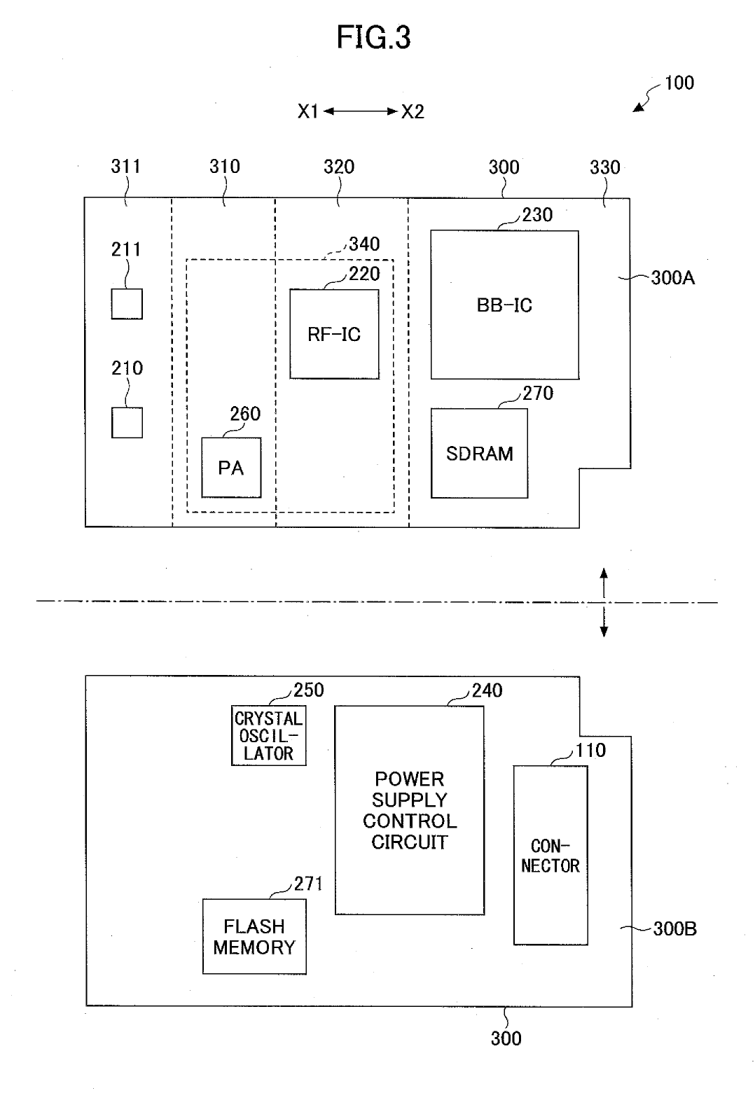

Next, the mounting substrate 300 of this embodiment will be described with reference to FIG. 3. FIG. 3 is a diagram showing the composition of the mounting substrate 300 of the radio communication device of the first embodiment.

The radio communication device 100 of this embodiment includes the mounting substrate 300. This substrate 300 is a double-sided mounting substrate, and the circuits shown in FIG. 2 are mounted on the substrate 300. All the circuits shown in FIG. 2 are actually mounted on the mounting substrate 300. For the sake of convenience, however, only some of the circuits shown in FIG. 2 are illustrated in FIG. 3.

Referring to FIG. 3, the circuits mounted on the front surface 300A of the mounting substrate 300 and the circuits mounted on the back surface 300B of the mounting substrate 300 will be described.

As shown in FIG. 3, in the mounting substrate 300 of this embodiment, the power amplifier 260 is mounted on the front surface 300A and the crystal oscillator 250 is mounted on the back surface 300B. In this embodiment, the power amplifier 260 and the crystal oscillator 250 are arranged on different surfaces of the substrate respectively, namely the front surface 300A and the back surface 300B. Hence, it is possible for this embodiment to prevent the crystal oscillator 250 from being considerably affected by the heat generated in the power amplifier 260.

It is assumed that the signal flows between the antennas 210, 211 and the BB-IC 230 in this embodiment are the same as the signal flows previously described with reference to FIG. 2.

In the following, an area where the power amplifier 260 is arranged on the substrate 300 will be referred to as an amplification area 310, an area where the RF-IC 220 is arranged on the substrate 300 will be referred to as an RF area 320, and an area where the BB-IC 230 is arranged on the substrate 300 will be referred to as a baseband area 330.

In the radio communication device 100 of this embodiment, an the front surface 300A of the mounting substrate 300, the RF-IC 220 is arranged between the power amplifier 260 and the BB-IC 230, so that the RF area 320 is interposed between the amplification area 310 and the baseband area 330. The amplification area 310 is located adjacent to an input/output (I/O) area 311 where the antennas 210 and 211 for transmitting and receiving a signal are arranged. Hence, on the front surface 300A of the mounting substrate 300, the circuits are arranged in the X1 to X2 direction to be in accordance with the sequence of the input/output area 311, the amplification area 310, the RF area 320 and the baseband area 330. The signals received by the antennas 210 and 211 are sent from the antennas 210 and 211 to the RF-IC 220 in the RF area 320 and the BB-IC 230 in the baseband area 330 in this order. Therefore, the signals flow in the X1 to X2 direction as indicated by the arrow in FIG. 3.

When transmitting a signal from the antenna 210, the signal to be transmitted is processed through the baseband area 330, the RF area 320 and the amplification area 310, and the processed signal is transmitted from the antenna 210. Therefore, the signal flows in the X2 to X1 direction as indicated by the arrow in FIG. 3.

In this embodiment, the above signal flows are maintained, the signals will not be fed backward, and it is possible to prevent unnecessary noises from being overlapped on the signals.

It is preferred that the position where the crystal oscillator 250 is arranged on the back surface 300B, in this embodiment, is distant from the position the power amplifier 260 on the front surface 300A. By arranging the crystal oscillator 250 in a position distant from the power amplifier 260, the influence of the generated heat on the crystal oscillator 250 can be reduced.

Next, the heat dissipation in the radio communication device 100 of this embodiment will be described.

It is preferred to arrange the power amplifier 260, on the front surface 300A of the mounting substrate 300 of this embodiment, in a position that is adjacent to the outer peripheral edge of the mounting substrate 300 as much as possible. The mounting substrate 300 of this embodiment is accommodated in the shielding case 110 made of metal. A part of the mounting substrate 300 is fixed to the case 110. When the mounting substrate 300 is accommodated in the case 110, the power amplifier 260 and the case 110 are in close proximity with each other if the power amplifier 260 is located near the outer peripheral edge of the mounting substrate 300. Because the case 110 of this embodiment is made of metal, the heat generated in the power amplifier 260 easily dissipates through the case 110. Therefore, in this embodiment, the rise of the temperature in the radio communication device 100 can be prevented, and the case 110 of this embodiment functions as a shield to RF signals.

In this embodiment, the case 110 is made of metal and the mounting substrate 300 is accommodated in the case 110. However, the present disclosure is not limited to this embodiment.

Alternatively, the case 110 of the radio communication device 100 of this embodiment may be made of another material, such as a resin. In such a case, a shield, made of metal, for covering only the power amplifier 260 and the RF-IC 220 on the surface 300A of the mounting substrate 300, may be provided. This shield may be provided to cover the area 340 on the surface 300A of the mounting substrate 300, as indicated by the dotted line in FIG. 3. The mounting substrate 300 with the shield provided therein may be accommodated in the resin case 110.

Even when a shield is provided in the area 340, the power amplifier 260 is arranged in a position near the shield, and the heat generated in the power amplifier 260 easily dissipates through the shield.

As described above, in this embodiment, the influence of the heat from the power amplifier 260 on the crystal oscillator 250 can be reduced, and it is possible to increase the stability and reliability of the crystal oscillator 250. In this embodiment, the power amplifier 260 is arranged in a position adjacent to the metal shield, and the heat generated in the power amplifier 260 can efficiently dissipate.

Next, a second embodiment of the present disclosure will be described.

In a second embodiment of the present disclosure, a one-side mounting substrate is used. In this embodiment, a power amplifier and a crystal oscillator are mounted on the one-side mounting substrate to be distant from each other as much as possible, thereby preventing the crystal oscillator from being considerably affected by the heat generated in the power amplifier.

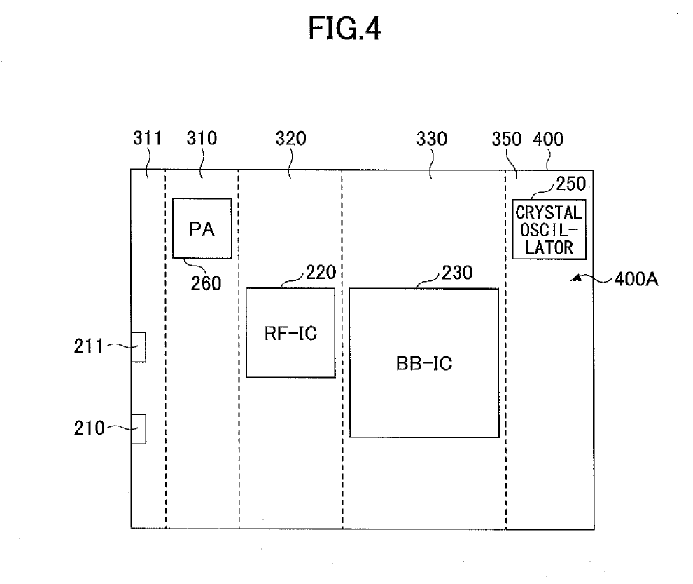

FIG. 4 is a diagram showing the composition of a mounting substrate of the radio communication device of the second embodiment. The substrate 400 of this embodiment is a one-side mounting substrate. Similar to the first embodiment, on the surface 400A of the mounting substrate 400, the RF-IC 220 is arranged between the power amplifier 260 and the BB-IC 230, so that the RF area 320 is interposed between the amplification area 310 and the baseband area 330.

In this embodiment, a crystal oscillation area 350 where the crystal oscillator 250 is mounted on the surface 400A is arranged to be adjacent to the baseband area 330, and this crystal oscillation area 350 is located at an end portion of the surface 400A of the mounting substrate 400.

As described above, in this embodiment, the amplification area 310 where the power amplifier 260 is mounted and the crystal oscillation area 350 where the crystal oscillator 250 is mounted are arranged on the same surface 400A to be distant from each other as much as possible.

Accordingly, it is possible for this embodiment to prevent the crystal oscillator 250 from being considerably affected by the heat generated in the power amplifier 260.

Next, a description will be given of a third embodiment of the present disclosure. The radio communication device of the third embodiment differs from the radio communication devices of the first and second embodiments in that the functions of the RF-IC 220 and the BB-IC 230 in the foregoing embodiments are performed by a single communication-control IC in a radio communication device 100A of this embodiment.

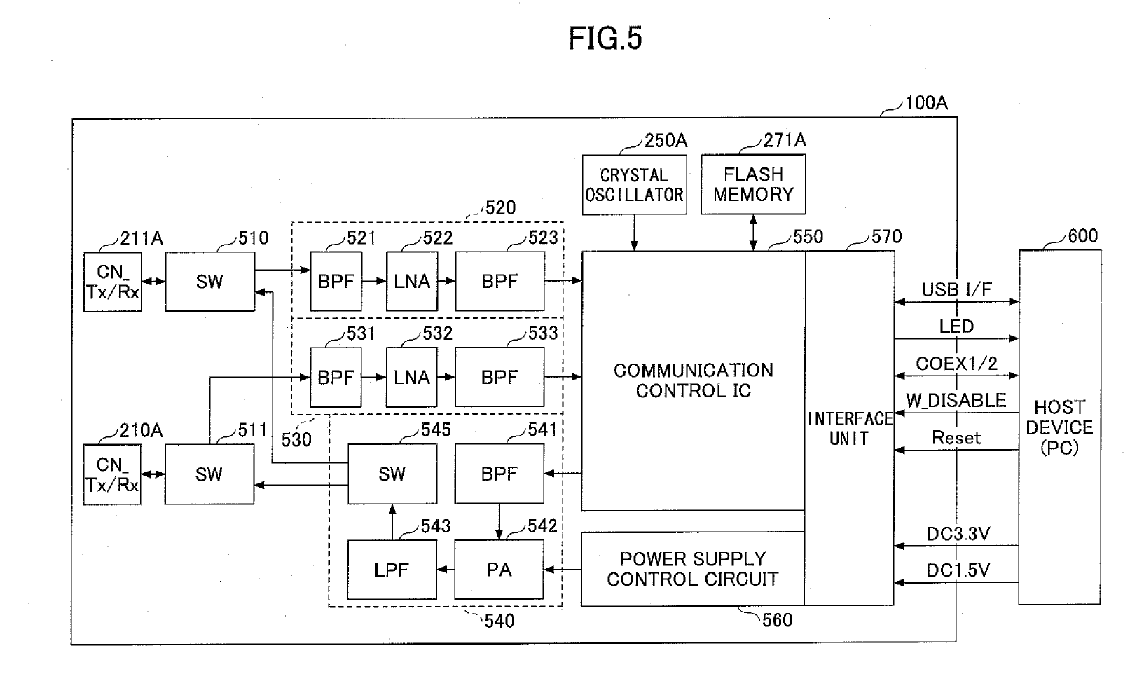

FIG. 5 is a block diagram showing the functional composition of the radio communication device of the third embodiment of the present disclosure.

As shown in FIG. 5, the radio communication device 100A of this embodiment is constructed to include antenna connectors 210A, 211A, switches (SW) 510, 511, receiving circuit parts 520, 530, a transmitting circuit part 540, a communication control IC 550, a power supply control circuit 560, an interface unit 570, a crystal oscillator 250A, and a flash memory 271A.

First, the transmitting circuit part 540 of the radio communication device 100A of this embodiment will be described.

In the embodiment shown in FIG. 5, the interface unit 570 is connected to a host device 600, such as a personal computer (PC). Signals received from the host device 600 through the interface unit 570 are input to the communication control IC 550. The electric power received from the host device 600 is supplied to the power supply control circuit 560.

A reference clock signal from the crystal oscillator 250A is input to the communication control IC 550, and the communication control IC 550 reads out the program and data stored in the flash memory.

The communication control IC 550 is constructed to include a baseband processing part and an RF circuit part. The communication control IC 550 outputs to the band pass filter 541 a transmitting signal which is produced by converting a digital signal into a signal of an output frequency. An output signal of a predetermined frequency which is passed through the band pass filter 541 is input to the power amplifier 542, and the output signal is amplified by the power amplifier 542.

The supply of electric power to the power amplifier 542 and the control of the electric power supplied to the power amplifier 542 are performed by the power supply control circuit 560. The transmitting signal amplified by the power amplifier 542 is input to the low pass filter 543. The transmitting signal from which unnecessary harmonic noise components are removed by the low pass filter 543 is output to the switch 545.

Based on the transmitting situation of the antennas (not shown), it is determined at the switch 545 which of the antenna on the side of the antenna connector 210A and the antenna on the side of the antenna connector 211A is to be selected. The transmitting signal from the switch 545 is output to one of the switches 510 and 511 whose transmitting situation is better.

The transmitting signal which is passed through the switch 510 or the switch 511 is output to one of the antenna connector 210A and the antenna connector 211A, so that the signal is transmitted from the selected antenna connector. The band pass filter 541, the power amplifier 542, the low pass filter 543, and the switch 545 are the component parts of the signal transmitting circuit part 540.

Next, the receiving circuit parts 520 and 530 of the radio communication device 100A of this embodiment will be described. A signal received from the antenna connector 211A is input to the band pass filter 521 through the switch 510. The received signal is filtered by the band pass filter 521 to output the received signal of a predetermined frequency range. The received signal is amplified by the low noise amplifier 522 and input to the band pass filter 523.

The received signal of the predetermined frequency range which is passed through the band pass filter 523 is detected by the RF circuit part of the communication control IC 550 and converted into a digital signal. The flow of the received signal from the antenna connector 211A is equivalent to the flow of the signal of the receiving circuit part 520, and the band pass filter 521, the low noise amplifier 522, and the band pass filter 523 are the component parts of the receiving circuit part 520.

Similarly, a signal received from the antenna connector 210A is input to the band pass filter 531 through the switch 511. The received signal is filtered by the band pass filter 531 to output the received signal of a predetermined frequency range. The received signal is amplified by the low noise amplifier 532 and input to the band pass filter 533.

The received signal of the predetermined frequency range which is passed through the band pass filter 533 is detected by the RF circuit part of the communication control IC 550 and converted into a digital signal. The flow of the received signal from the antenna connector 210A is equivalent to the flow of the signal of the receiving circuit part 530, and the band pass filter 531, the low noise amplifier 532, and the band pass filter 533 are the component parts of the receiving circuit part 530.

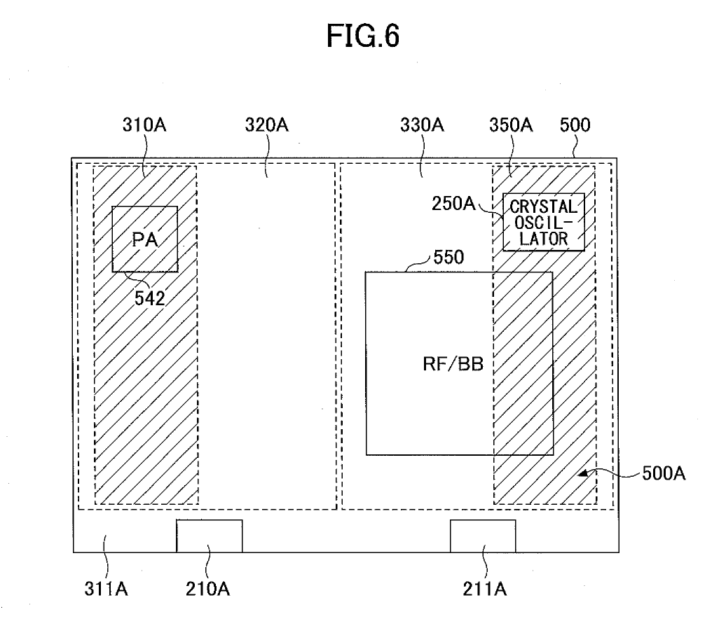

FIG. 6 is a diagram showing the composition of the mounting substrate 500 of the radio communication device 100A of the third embodiment.

As shown in FIG. 6, the substrate 500 of this embodiment is a one-side mounting substrate. On the surface 500A of the mounting substrate 500, an amplification area 310A, an input/output area 311A, a transmitting/receiving circuit area 320A, a communication control area 330A, and a crystal oscillation area 350A are arranged.

The input/output area 311A is an area where the antenna connector 210A and the antenna connector 211A are mounted. The amplification area 310A is an area where the power amplifier 542 is mounted. The transmitting/receiving circuit area 320A is an area where the receiving circuits 520 and 530 and the transmitting circuit 540 are mounted. The communication control area 330A is an area where the communication control IC 550 is mounted. The crystal oscillation area 350A is an area where the crystal oscillator 250A is mounted.

The communication control IC 550 of this embodiment has a function that is performed by the RF-IC 220 and the BB-IC 230. Hence, the communication control area 330A is arranged to include the RF area and the baseband area. In this embodiment, the communication control area 330A and the crystal oscillation area 350A are located in an overlapping position, and the crystal oscillation area 350A is included in the communication control area 330A. In other words, in this embodiment, the crystal oscillator 250A is mounted at an upper right corner of the communication control area 330A on the substrate as shown in FIG. 6.

In this embodiment, the amplification area 310A and the transmitting/receiving circuit area 320A are located in an overlapping position, and the amplification area 310A is included in the transmitting/receiving circuit area 320A. In other words, in this embodiment, the power amplifier 542 is mounted at an upper left corner of the transmitting/receiving circuit area 320A on the substrate as shown in FIG. 6.

In this embodiment, a part of the communication control area 330A is arranged between the amplification area 310A and the crystal oscillation area 350A, and a part of the transmitting/receiving circuit area 320A is arranged between the amplification area 310A and the communication control area 330A.

Accordingly, in this embodiment, the receiving circuits 520 and 530, the transmitting circuit 540, and the communication control IC 550 are mounted between the power amplifier 542 and the crystal oscillator 250A. Therefore, in the mounting substrate 500 of this embodiment, the power amplifier 542 and the crystal oscillator 250A are mounted on the mounting substrate 500 at the positions distant as much as possible, and it is possible to prevent the crystal oscillator 250A from being considerably affected by the heat generated in the power amplifier 542.

As described in the foregoing, according to the present disclosure, it is possible to provide a radio communication device which takes into consideration of heat dissipation and is capable of increasing the stability and reliability of a crystal oscillator.

The present disclosure is not limited to the above-described embodiments, and variations and modifications may be made without departing from the scope of the present disclosure.

What is claimed is

1. A radio communication device including a mounting substrate and a shielding case to cover circuits mounted on the substrate, a first surface of the substrate comprising:
an input/output area where a transmitting/receiving unit of an RF signal is mounted on the first surface;
an amplification area, located adjacent to the input/output area, where an amplifying unit to amplify the RF signal from the transmitting/receiving unit is mounted on the first surface;
an RF area, located adjacent to the amplification area, where an RF processing unit to process the RF signal from the transmitting/receiving unit is mounted on the first surface; and
a baseband area, located adjacent to the RF area is adjoined, where a baseband processing unit to process a baseband signal which is an intermediate signal before modulation of the RF signal or an intermediate signal after demodulation is mounted on the first surface, and
a second surface of the substrate opposite to the first surface comprising a crystal oscillator arranged on the second surface to generate a reference clock signal which is supplied to the RF processing unit and the baseband processing unit.

2. The radio communication device according to claim 1, wherein the crystal oscillator is arranged on the second surface of the mounting substrate in a position where the crystal oscillator does not overlap with the amplifying unit arranged on the first surface of the mounting substrate.

3. The radio communication device according to claim 1, wherein the amplifying unit is arranged in a vicinity of the shielding case.

4. A radio communication device including a mounting substrate and circuits mounted on the substrate, a single surface of the substrate comprising:
an input/output area where a transmitting unit to transmit an RF signal and a receiving unit to receive an RF signal are mounted on the surface;
a transmitting/receiving unit area where a transmitting circuit to supply the RF signal to the transmitting unit and a receiving circuit to receive the RF signal received by the receiving unit are mounted on the surface;
an amplification area where an amplifying unit to amplify the RF signal to be transmitted by the transmitting unit is mounted on the surface;
a communication control area where a communication control unit including an RF processing unit to process the RF signal to be transmitted by the transmitting unit or received by the receiving unit, and a baseband processing unit to process a baseband signal which is an intermediate signal before modulation of the RF signal or an intermediate signal after demodulation is mounted on the surface; and
a crystal oscillation area where a crystal oscillator to generate a reference clock signal to be supplied to the communication control unit is mounted on the surface,
wherein a part of the communication control area is arranged between the amplification area and the crystal oscillation area.

5. The radio communication device according to claim 4, wherein a part of the transmitting/receiving unit area is arranged between the communication control area and the amplification area.

6. The radio communication device according to claim 4, wherein the crystal oscillation area is arranged in a position that is overlapped with the part of the communication control area, and the crystal oscillator is disposed at an end portion of the communication control area.

7. The radio communication device according to claim 4, wherein the amplification area is arranged in a position that is overlapped with a part of the transmitting/receiving unit area, and the amplifying unit is disposed at an end part of the transmitting/receiving unit area.

8. The radio communication device according to claim 4, wherein the communication control area and the transmitting/receiving unit area are arranged adjacent to each other.
